(19) United States
(12) Patent Application Publication
(10) Pub. No.: US 2004/0263840 A1
(43) Pub. Date: Dec. 30, 2004

(54) Calibration of reconfigurable inspection machine

(76) Inventors: Stephen B. Segall, Ann Arbor, MI (US); Juris Upatnieks, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 10/852,716

(22) Filed: May 24, 2004

Related U.S. Application Data
(60) Provisional application No. 60/482,406, filed on Jun. 25, 2003.

(51) Int. Cl. G01J 1/10; G01B 11/02

(52) U.S. Cl. 356/243.1

(57) ABSTRACT

A method for calibrating an inspection machine including a plurality of displacement detectors for inspecting a production part and a linear motion stage for relative motion between the displacement detectors and the production part. The method includes determining relative positional errors of the displacement detectors relative to each other, determining the effect of motion stage errors on a first detector from the plurality of displacement detectors as a function of position of the motion stage, and determining the effect of motion stage errors on the remaining displacement detectors as a function of position of the motion stage.

### CROSS-REFERENCE TO RELATED APPLICATIONS

This application claims the benefit of U.S. Provisional Application No. 60/482,406, filed on Jun. 25, 2003. The disclosure of the above application is incorporated herein by reference.

### FEDERALLY SPONSORED RESEARCH

Certain of the research leading to the present invention was sponsored by the United States Government under National Science Foundation Grant No. EEC-959125. The United States Government has certain rights in the invention.

### INTRODUCTION

Manufactured parts used in precision machinery such as automotive powertrains must be manufactured within tight tolerances. Determining whether parts are within tolerance is an important aspect of modern manufacturing. On a production line one wishes to rapidly determine whether a part is good or defective. The longer it takes to identify a defective part while a production line is running, the more scrap is likely to be produced. It is therefore desirable to have in-process inspection to rapidly identify problems, determine their root causes and minimize scrap, such as the reconfigurable inspection machine (RIM) disclosed in U.S. Pat. No. 6,567,162, which is incorporated herein by reference.

In an in-process inspection machine a part moves relative to an array of detectors that measure the part. To calibrate the inspection machine the effect of inspection system errors on the detector reading is determined so that such errors can be removed in the data reduction process.

### SUMMARY

The present teachings provide a method for calibrating an inspection machine including a plurality of displacement detectors for inspecting a production part and a linear motion stage for relative motion between the displacement detectors and the production part. The method includes determining positional errors of the displacement detectors relative to each other, determining the effect of motion stage errors on a first detector from the plurality of displacement detectors as a function of position of the motion stage, and determining the effect of motion stage errors on the remaining displacement detectors as a function of position of the motion stage.

The present teachings also provide an inspection machine for a production part. The inspection machine includes a plurality of first detectors for measuring a surface profile of the production part, a linear motion stage for relative motion between the first detectors and the production part, a strip mirror stationary relative to the production part, a second detector for measuring displacement between the strip mirror and the second detector, and a third detector device for simultaneous and continuous measurement of geometric errors of the linear motion stage. The strip mirror, the second detector and the third detector device are configured for determining the effects of motion stage errors on the first detectors such that the motion stage errors can be removed from the surface profile measurement of the production part.

The present teachings also provide a method for continuously determining the effects of motion stage errors on a plurality of first detectors of an inspection machine having a linear motion stage, wherein the first detectors measure a production part profile. The method includes attaching a strip mirror on the inspection machine, providing a second detector for measuring displacements from the strip mirror, providing a third detector device for directly measuring geometric motion stage errors, measuring continuously and simultaneously geometric errors of the linear motion stage, measuring displacements between the strip mirror and the second detector, determining effects of motion stage errors on the second detector, and removing the effects motion stage errors from the first detectors.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a prior art inspection machine;

FIG. 1A is a side view of an inspection machine with calibration reference part according to the present teachings;

FIG. 2 is a side view of an inspection machine with calibration mirror according to the present teachings;

FIG. 3 is a perspective view of an inspection machine according to the present teachings;

FIG. 4 is a perspective view of an inspection machine according to the present teachings;

FIG. 5 is a perspective view of an inspection machine according to the present teachings;

FIG. 6A is a top view of an optical amplification system according to the present teachings;

FIG. 6B is an end view of an optical amplification system according to the present teachings;

FIG. 7 is a top view of a position sensing detector array according to the present teachings;

FIG. 8 illustrates non parallelism of the rails of a motion stage producing roll;

FIG. 9 is a top view of a position sensing detector array according to the present teachings;

FIG. 10 is a top view of a position sensing detector array according to the present teachings shown with a plane mirror to measure roll due to non parallelism of the rails of the linear motion stage;

FIG. 11 is a is a top view of an optical amplification system according to the present teachings;

FIG. 12 illustrates a ray of light traversing a glass plate of the optical amplification system of FIG. 11;

FIG. 13 is a top view of an optical amplification system according to the present teachings;

FIG. 14 is a top view of an optical amplification system according to the present teachings;

FIG. 15 is a top view of an optical amplification system according to the present teachings;

FIG. 16 is a side view of an optical amplification system according to the present teachings;

FIG. 17 is a perspective view of the configuration of the beam splitters and mirrors of the optical amplification system of FIG. 16; and

FIG. 18 is a perspective view of a compact configuration of the beam splitters and mirrors of the optical amplification system of FIG. 16.

### DETAILED DESCRIPTION

The following description is merely exemplary in nature and is in no way intended to limit the invention, its application, or uses. For example, although calibration methods are illustrated for a reconfigurable inspection machine, the invention is not so limited, and the present teachings can be applied to any inspection machine and any system in which an array of detectors is used to perform dimensional measurements on an object in relative motion with respect to the detector array for any purpose. Since the motion of the part with respect to the detectors is relative motion, the present teachings apply both in the case where the part is moving relative to the detector array and the case where the part is stationary and the detector array moves as a unit past the part.

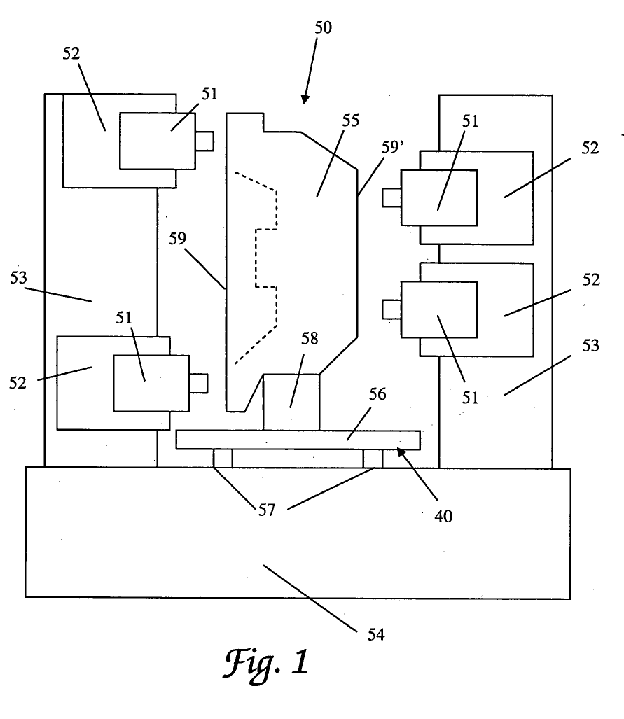

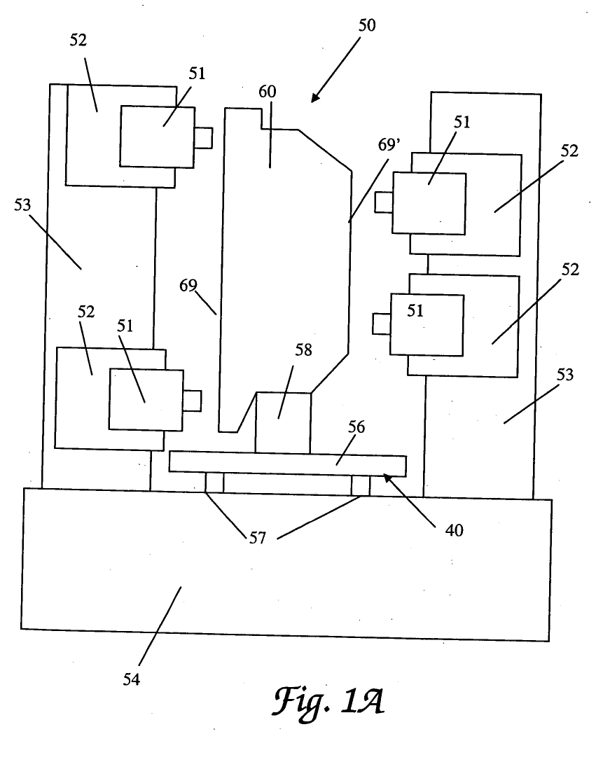

Referring to FIG. 1, a prior art reconfigurable inspection machine (RIM) 50 is illustrated. The prior art RIM 50 includes inspection detectors 51 mounted on mounting plates 52 which are attached to support columns 53. The support columns 53 are attached to base 54 of the inspection machine. Each detector 51 is placed at a distance from a surface of a production part 55 that is within the measurement range of the detector 51. The production part 55 is mounted on a fixture 58 which holds the production part 55 rigidly with respect to a carriage 56 that moves along rails 57 defining a linear motion stage 40. As the carriage 56 moves along rails 57 each detector 51 produces a linear scan of its distance to the surface of the production part 55 from which information about the surface profile of the production part 55 can be obtained. The prior art RIM 50 is reconfigurable in that the number, type and position of the inspection detectors 51 of the array can be changed to accommodate parts 55 that are members of a family of parts with similar measurement requirements or to upgrade the measurement technology.

One type of detector 51 that can be used in a part inspection machine is a displacement detector. A displacement detector measures the distance to a part surface. As a part moves past the detector, data for displacement (variation in distance to the surface) as a function of position of the part carriage 56 along the linear motion stage 40 can be obtained. This data contains information both about the surface profile of the production part 55 and the errors of the motion stage 40, which also produce displacements of the part surface from the detector 51. To obtain an accurate linear part profile from the displacement detector signal, the contribution to the signal from the errors of the motion of the carriage 56 on the rails 57 must be removed from the data.

The displacement detector 51 can be an optical detector. An optical displacement detector projects a beam of light onto the surface of the part and measures variation of the distance from the surface of the part to the detector as the part moves along the axis of the motion stage. Several different types of optical displacement detectors are available for this type of inspection machine. These may include detectors based on triangulation, confocal microscopy, scattering or interference techniques. One example of a displacement detector is the Optimet conoprobe detector available from Optical Metrology Inc., Wilmington, Mass.

The inspection detectors 51 of prior art reconfigurable inspection machines (RIM) are calibrated to provide accurate profiles of machined surfaces and features. The inspection detectors 51 function together as an integrated system in order to supply information about properties such as the flatness, waviness, parallelism and distance between machined surfaces and features. Although the calibration of each of the individual inspection detectors 51 is known, the entire system of inspection detectors 51 may require calibration to eliminate positioning errors and motion stage errors from the data produced. It will be understood that the prior art inspection machine 50 may include position sensors for measuring the position of the carriage 56 on which the production part 55 is mounted along the rails 57 at any instant of time during a part measurement. The position sensor can be a linear scale, motion stage encoder or laser interferometer. It is further understood that the data collection system of the prior art inspection machine 50 can correlate part measurement data with position of the carriage 56 along its rails 57.

There is a difference between a machine used to manufacture a part and a machine used to inspect a part. In a machine that manufactures a part, such as a machining system that removes material from a part, the cutting tool must be precisely located or the part may be defective. Therefore, if a detector system measures errors in the position of a cutting tool, those errors must be corrected or compensated by supplying an error map to the machine controller which compensates for the errors to the extent possible.

In an inspection machine no material is being removed, and it is not necessary for a machine controller to compensate for errors of the motion stage. It is only necessary to know the errors so they can be corrected in the data reduction process. Even with real time measurements and feedback to a machine controller it is not possible to totally eliminate the effect of random errors on a machined part, because by the time the errors are measured they have already affected the geometry of the part surface. However, in an inspection machine, if errors are measured continuously, random as well as repeatable errors could be corrected during the data reduction process.

Another difference between a cutting machine and an inspection machine is that in an inspection machine the environment is not as severe, making optical measurement techniques easier to implement. Environmental factors such as chips, fluid and vibration due to cutting would be absent in an inspection machine.

The present teachings include methods for determining detector positioning errors and linear motion stage mechanical errors so that the effect of these errors on the detector readings can be compensated automatically during processing of the data from a detector array. Without such error compensation the results obtained from the measurement process will not be accurate.

Referring to FIG. 1A, for an array of inspection detectors 51 to obtain three-dimensional information about the surface of production part 55, the location of each detector 51 must be precisely known relative to the other inspection detectors 51 of the array. The effect of motion stage errors on the individual detector signals must also be known. According to the present teachings, this information is determined by measuring a reference part 60 with precisely known dimensions using the array of inspection detectors 51.

The reference part 60 will usually be different than production part 55. The reference part 60 has surfaces or profile 69 at approximately the same locations as the surfaces 59 to be inspected of production part 55. This is because the displacement inspection detectors 51 have finite working ranges and are positioned at locations for which the surfaces 59 of production part 55 will be within these ranges. To calibrate the inspection detectors 51 using the reference part 60, the reference part 60 is configured such that the surfaces 69 of the reference part 60 also be within the same ranges.

The reference part 60 that is used to calibrate the reconfigurable prior art inspection machine 50 is different than an artifact used to calibrate a coordinate measuring machine (CMM). In a CMM a precisely manufactured artifact with specific machined features is used to calibrate a single touch probe. The reference part 60 for the present teachings is used to calibrate multiple inspection detectors 51 simultaneously and would generally have smooth surfaces. If there were machined features on the surface 69 of the reference part 60, data for calibration purposes could be lost if the depth of the features exceeded the working range of the inspection detectors 51. Typical ranges for a number of optical detectors such as the Optimet conoprobe are on the order of millimeters. Markings can, however, be made on the surface 69 of the reference part 60 to facilitate comparison of measurements from different types of inspection detectors 51. Such markings can be, for example, periodic scribe marks.

Various instruments that can be used to obtain three dimensional surface profiles of the reference part 60. These instruments usually require more time to measure parts than the time required to perform part measurements on the RIM 50. However, they are appropriate for measuring the reference part 60 for calibration purposes. Examples of instruments that can provide three dimensional surface profiles 69′ of the reference part 60 are the flatness gauge of OG Technology, Ann Arbor, Mich., the holomapper of Coherix, Grandville, Mich., or a high precision CMM, such as those manufactured by Zeiss, Brighton, Mich.

The reference part 60 is measured using the array of inspection detectors 51. The difference between the reference part profiles obtained from the signals of inspection detectors 51 and the known surface profile 69′ of the reference part 60 gives a continuous series of correction factors for each detector 51. When the instrument used to obtain a three dimensional surface profile has the same depth and spatial resolution as the inspection detectors 51, a map of correction factors as a function of position can be obtained. The correction factors include the coupled effect of motion stage errors and detector positioning errors. It is not necessary to decouple the errors in order to calibrate the inspection detectors 51. A map of the correction factors for each detector 51 as a function of position is then used by a data reduction software 80 to provide a corrected profile 59′ of the production part 55 from the measurements of inspection detectors 51.

When the instrumentation used to provide a three-dimensional (3D) map of the reference part 60 has different depth resolution and area spatial resolution than the displacement inspection detectors 51, the mean distance to the reference part 60 along a linear profile is compared with the relative position of the surface 69 of the reference part 60 along the same linear profile 69′ as determined from the 3D surface map of the reference part 60. Correction factors can then be applied for the positions of inspection detectors 51 relative to the reference part surface 69, by known methods, such as the method described in “Calibration of a Reconfigurable Inspection Machine for Engine Heads” by Segall, Fricker and Gupta, Proceedings of the 2002 Global Power Train Conference, September 2002.

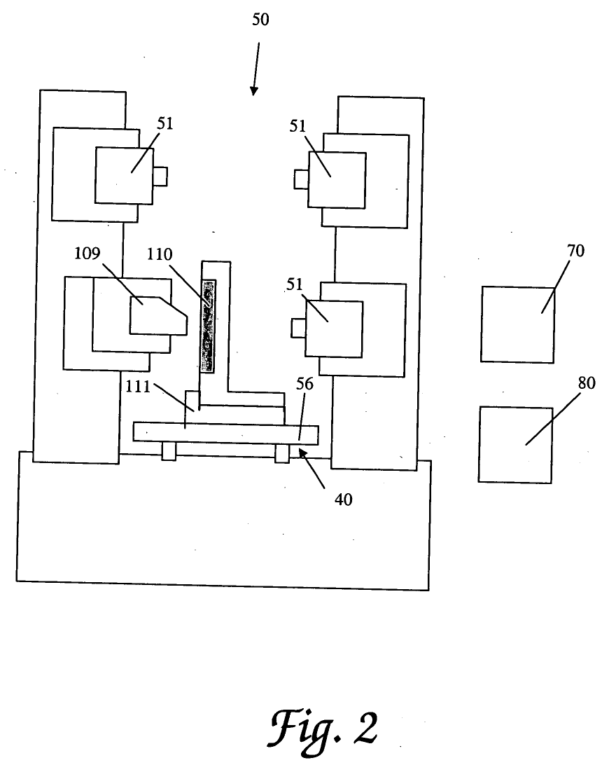

In addition to positioning errors of the inspection detectors 51 relative to each other there are also errors produced by the linear motion stage 40. These errors can be different for each of the inspection detectors 51 in the array. Referring to FIG. 2, the effect of motion stage errors on the signal of one of the displacement detector 51 are determined by replacing the production part 55 to be measured and fixture 58 with an interferometrically flat mirror 110 on a mirror fixture 111. As the mirror 110 moves past the detector 51 any variation from a linear signal will be due to errors of the motion stage 40. If the displacement detector 51 of the prior art inspection machine 50 cannot measure a mirror surface, a displacement detector that can measure a mirror surface (“mirror measuring detector”) 109 can replace the detector 51 to perform the calibration. The mirror measuring detector 109 can also be placed opposite the detector 51 used to measure a production part 51 and facing the mirror 110. For example, the inspection detectors 51 can be Optimet conoprobe detectors that measure scattered light and cannot accurately measure the position of a mirror surface. The mirror measuring detector 109 can be a confocal microscope or triangulation detector that can measure a mirror surface. Any deviation of the signal of mirror measuring detector 109 from a linear profile is the result of motion stage errors on a detector at that location. It is not necessary to decompose the errors of the motion stage into their various components to utilize the measurement of mirror displacements. Only the resultant of all of the errors of the motion stage together on the detector signal is needed to correct for the effect of motion stage errors on the linear profile obtained by the detector 109.

The mirror 110 can be a single large mirror that covers the entire measurement range or a smaller mirror that measures the range in segments with some overlap. The segments could then be stitched together to cover the entire range for a part measurement. Also, instead of an interferometrically flat mirror 110, a smooth surface for which the surface profile is known with interferometric accuracy can be used. In this case the measured displacement profile is corrected for the deviation of the surface from true flatness in order to determine the effect of the motion stage errors on the detector 109.

The effect of motion stage errors on each of the inspection detectors 51 of the prior art inspection machine 50 can be obtained by measuring the signal returned from a mirror, such as the mirror 110, which is placed facing each detector 51. Alternatively, the displacement due to motion stage error can also be measured at one location and calculated at any other location when the errors of the motion stage are known as a function of position along the axis of motion of the linear motion stage 40. For example, if two inspection detectors 51 are located at the same height relative to the carriage 56 but at different locations along the axis of motion, a yaw error results in the measured displacements for the two inspection detectors 51 being different by an amount equal to the angular error times the horizontal distance between the detectors. If two inspection detectors 51 are at the same axial location but at different heights relative to the carriage 56, a roll error causes the detector readings to be different. If a line scan camera is used to obtain images of machined features of a production part 55, vertical straightness errors could affect the accuracy of the image. The pitch error between the location of the detector measuring the mirror and the location of the line scan camera needs to be known to correct for vertical motion at the location of the camera.

All motion stage errors can be measured using instrumentation 70. The instrumentation 70 can include a laser interferometer and an electric level. The laser interferometer can measure all motion stage errors except roll. Roll can be measured separately using an electric level. Combining these measurements with the effect of motion stage errors at one detector location provides correction functions for motion stage errors for all of the inspection detectors 51 of the prior art inspection machine 50.

According to the present teachings, an interferometrically flat mirror (or a flat part with a smooth surface measured with interferometric accuracy) 110 can be used to determine the effect of motion stage errors on a detector 51 at a given location as a function of position of carriage 56 along the linear motion stage 40. If the inspection detectors 51 of the prior art inspection machine 50 can measure displacement from a mirror surface, one of these inspection detectors 51 can be used to measure displacement as a function of carriage position. If the inspection detectors 51 cannot measure a mirror surface, another detector 109 can be used in place of one of the inspection detectors 51 or placed opposite one of the inspection detectors 51 to measure the effect of motion stage errors on that detector 51. Independent measurements of motion stage errors obtained from the instrumentation 70 together with the profile obtained using the detector 109 can then be used to determine the effect of motion stage errors on any of the other inspection detectors 51 of the prior art inspection machine 50 for a given position of the carriage 56 along the motion stage 40. The correction factor for detector position obtained using a reference part 60 together with the values of motion stage errors for all of the inspection detectors 51 of the inspection machine as a function of position of the carriage 56 along the linear motion stage 40 can be incorporated into an error map, which can then be used by the data reduction software 80 to automatically correct for these errors and obtain accurate part profiles from which part parameters such as flatness and parallelism could be derived and compared with acceptable tolerances for each production part 55.

While the prior art inspection machine 50 of FIG. 1 shows a production part 55 passing through an array of inspection detectors 51 to produce relative motion between production part 55 and the inspection detectors 51 of the detector array, it is clear that this relative motion can also be produced with the production part 55 fixed and the inspection detectors 51 mounted on a linear motion stage 40 that moved past the production part 55. In such embodiment, the detector 109 that measures mirror displacement moves with the inspection detectors 51.

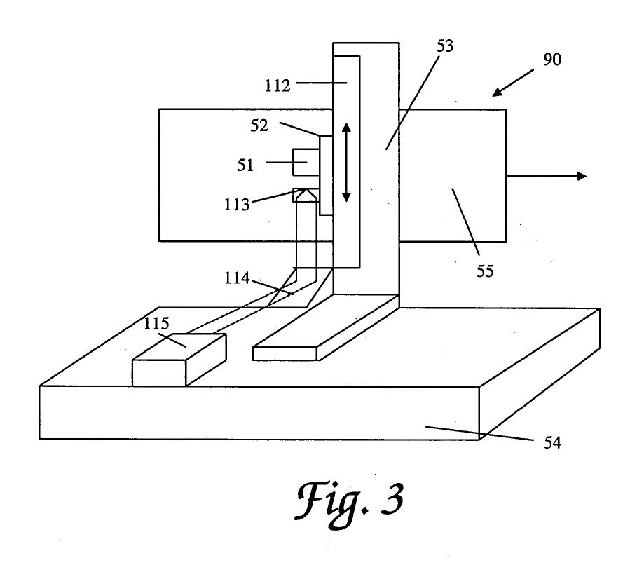

Referring to FIG. 3, an inspection machine 90 according to the present teachings can have one (or more) detector 51 and the mounting plate 52 of the detector mounted on one (or more) linear motion stage 112 (“detector motion stage”) to obtain profile information along paths that are not straight lines. For example, it may be desired to determine the part profile along a sinusoidally varying path on the surface of production part 55, instead of along straight line paths that are obtained when the inspection detectors 51 are fixed relative to each other and the production part 55 moves past the inspection detectors 51. The motion stage 112 on which the detector 51 is mounted has its own geometric errors that are measured and corrected as part of the data reduction process. The geometric errors include transverse displacements, yaw, roll and pitch. The position of detector motion stage 112 along its direction of motion can be determined from readings of instrumentation 70, such as a linear scale, interferometer or linear encoder. The detector motion stage 112 is mounted on the support column 53.

In many cases it may not be necessary to measure all of the geometric errors of linear motion stage 112 on which detector 51 is mounted to determine the effect of detector-motion-stage errors on the profile measurement of production part 55. If the production part surface is perpendicular to the axis of the detector 51, then only detector displacement in the direction of the production part 55 will influence the part profile measurement. This error can be measured by rigidly attaching a retroreflector 113 to the mounting plate 52 holding the detector 51. The signal returning from the retroreflector 113 can be used to determine transverse motion in the direction of production part 55. A transverse motion detector 115 is supported on the base 54. The transverse motion detector 115 includes a laser and a position sensitive detector or digital camera. The laser beam from transverse motion detector 115 is reflected from a mirror 114 into the retroreflector 114 from which it is reflected back into the motion detector 115 from mirror 114.

The transverse motion detector 115 detects motion of the retroreflector 113 in two directions orthogonal to the direction of motion of the detector-motion stage 112. The transverse displacement in the direction towards the production part 55 provides the error in the part displacement measurement. The transverse displacement orthogonal to this direction can be used to determine the error caused by detector motion stage 112 on feature location. By calibrating the position of the detector 51 on motion stage 112 relative to the other inspection detectors 51 of the inspection machine for at least one location along its trajectory using the reference part 60, transverse displacements of retroreflector 113 on the motion stage 112 can be determined relative to this reference location. Alternatively, the transverse motion of the detector motion stage 112 can be measured using an interferometer with an accessory for measuring transverse motion mounted on the mounting plate 52.

When the same calibration measurements are performed multiple times, the error values for each set of measurements can be slightly different. The differences are attributed to random errors. Random motion stage errors may be caused in part by the non-zero clearance between the carriage 56 and rails 57 of the motion stage 40 required for the motion of the carriage 56. There may also be small oscillations introduced by the carriage motion or the environment. Errors of the motion stage 40 may be velocity dependent, and can be different at operational speeds than at the velocity at which a calibration was performed.

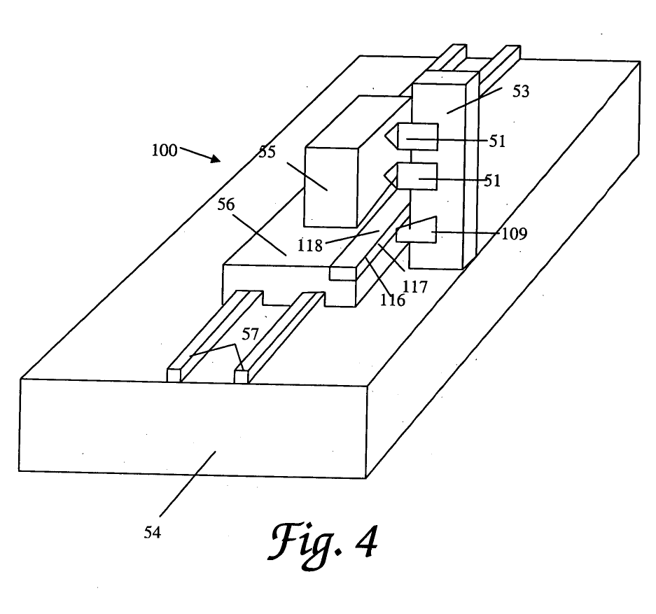

Referring to FIG. 4, a continuous calibration inspection machine 100 according to the present teachings provides calibration measurements that can be performed simultaneously with production part measurements, to correct for random as well as repeatable errors for the part measurements, thereby increasing the accuracy of obtained surface profiles. The inspection machine 100 can be a reconfigurable inspection machine. The inspection machine 100 includes, in addition to the standard base 54, rails 57, carriage 56, inspection detectors 51 and support column 53, a strip mirror 116 with a mirror surface 117 below the production part 55 attached along the length of carriage 56 and have a dedicated mirror measuring detector 109 to measure the mirror surface 117. For better stability, the mirror 116 can be made out of a rectangular slab of glass 118, having a long edge surface that is polished and coated for reflectivity to produce the mirror surface 117. The dimensions of slab 118 can be selected for rigidity. The mirror 116 does not have to be interferometrically flat, but its surface profile need to be known to interferometric accuracy.

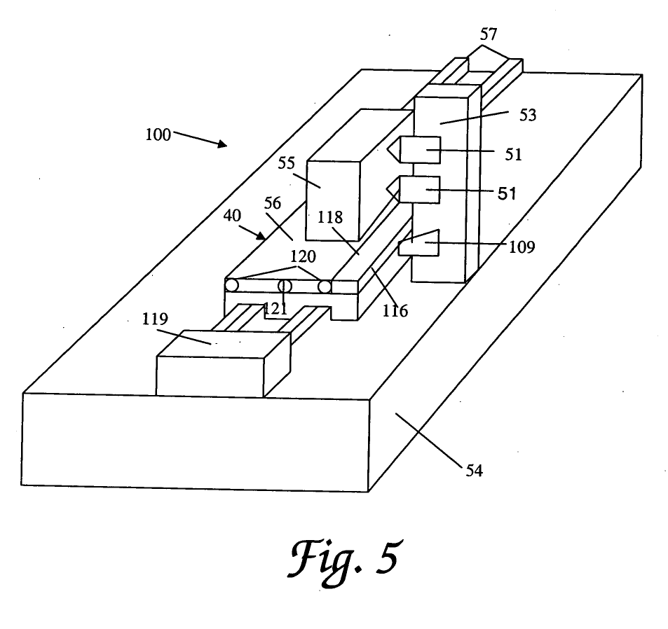

Referring to FIGS. 4 and 5, the signal from the detector 109 measuring displacement of the surface 117 of the mirror 116 gives the combined effect of motion stage errors only for mirror-measuring detector 109, and not for any of the inspection detectors 51 that are measuring the production part 55. To determine the effect of motion stage errors on the displacement signals for inspection detectors 51, we determine the motion stage errors as a function of position measured at the same time mirror 116 is measured. For corrections to displacement detector readings, the most important errors are yaw and roll. Continuous values for the geometric errors of carriage 56, including yaw and roll can be obtained with a position sensing detector (PSD) device that includes as a position sensitive detector array or one or more digital cameras. The PSD device is a device that simultaneously measures the errors of a linear motion stage. One such device can be obtained from API, Gaithersburg, Md. Another PSD device is described in “Integration of optical sensors into a reconfigurable machining module” by Segall and Upatnieks, Proceedings of the 2000 Japan-USA Symposium on Flexible Automation, Paper 13153, Ann Arbor, Mich. (July 2000).

A PSD device 119 is mounted on the base 54 of the inspection machine 100 and together with continuous measurement of displacements by the mirror-measuring detector 109 provides the data needed for correction of the effect of motion stage errors on displacement measurements for every displacement detector 51 at the time production part 55 is being measured, including the effect of random errors. To provide continuous measurement of motion stage errors the PSD device 119 is an integral part of the inspection machine 100. The inspection machine also includes two retroreflectors 120 and a plane mirror 121 on the carriage 56. The PSD device 119 generates internally three laser beams and directs two of the laser beams to the retroreflectors 120 and one laser beam to the plane mirror 121. The three beams are generated by splitting the output of a single laser, which is usually a diode laser, located inside the PSD device 119. The return signals from the retroreflectors 120 are detected by detectors also located inside PSD device 119 and used to determine transverse straightness errors and roll. The return signal from the plane mirror 121 is also detected and used to determine yaw and pitch as will be described below.

To ensure that there is always a displacement reading for mirror 116 when inspection detectors 51 are mounted on two or more columns or support structures 53, two mirror-measuring detectors 109 can be used. The mirror-measuring detectors 109 can be separated by up to the length of slab mirror 116. When this is done, there will always be at least one measurement of mirror displacement that can be used to calculate the effect of motion stage errors on the inspection detectors 51 at every place that measurements are being taken by the inspection detectors 51. Therefore, integration of slab mirror 116, detectors 109 and PSD device 119 into the inspection machine 100 to measure motion stage errors at the time the production part 55 is being measured provides the data needed for continuous correction of motion stage errors on displacement measurements of the production part 55. This permits correction of random as well as repeatable errors and increase the measurement accuracy of the inspection machine 100. It will be appreciated by those of ordinary skill in the art that the PSD device 119 can be positioned on carriage 56, and the retroreflectors 120 and the plane mirror 121 can be positioned on base 54.

Deviation from straight line motion can be determined by measuring the transverse displacement of a laser beam as a function of position along a linear motion stage 40, obtaining a best fit straight line through this data and calculating deviations from this straight line. These deviations are small quantities in which roll and transverse straightness errors are coupled. Roll and transverse straightness errors can be decoupled by taking the sums and differences of transverse displacement measurements obtained at two different locations on carriage 56. These values are sums and differences of small differences and therefore may contain significant errors. It is therefore desirable to optically amplify transverse displacements before they reach the electronic sensors inside PSD device 119 to increase the signal to noise ratio of these signals and thereby improve resolution. The retroreflectors 120 attached to carriage 56 of the linear motion stage 40 amplify transverse displacements by a factor of two compared with direct detection of displacements without any retroreflectors. Expansion of the beams returning from the retroreflector 120 before it reaches its detector can further amplify the transverse displacement. However, larger detectors with lower resolution may be needed to detect the displacement of these expanded beams. The API system, for example, measures displacements directly without any optical amplification.

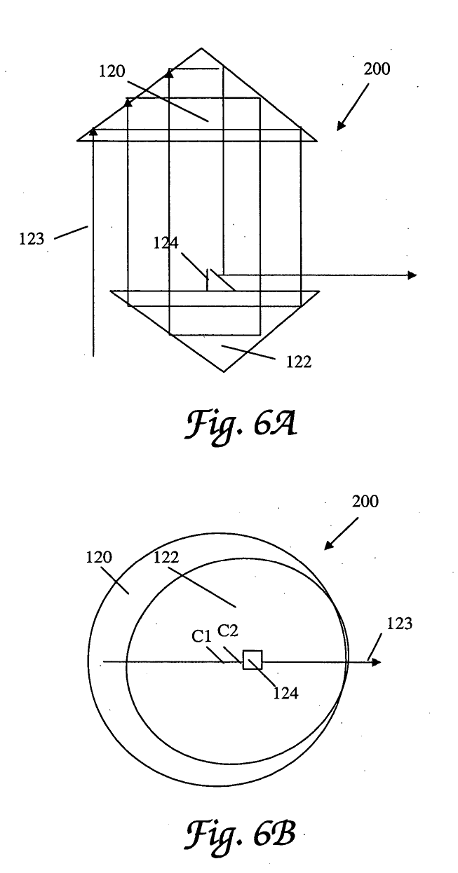

Referring to FIGS. 5, 6A and 6B, an optical amplification system 200 for obtaining optical amplification of transverse displacements by more than a factor of two is illustrated. The system includes first and second retroreflectors 120, 122 having respective centers C1 and C2 that are offset relative to each other. The first retroreflector 120 can be attached to carriage 56 of the inspection machine 100, and the second retroreflector 122 can be an internal component of PSD device 119. A ray of light 123 entering the first retroreflector 120 would make multiple round trips through the pair of retroreflectors 120, 122 before being deflected by a mirror 124 which is mounted on the second retroreflector 122. If the first retroreflector 120 is displaced transversely by a small amount Δx relative to retroreflector 122 as a result of the motion of carriage 56 along rails 57 of the linear motion stage 40, then on each path through the first retroreflector 120 the transverse displacement of the light ray 123 will increase by 2Δx relative to the retroreflector 122. This amplification will continue until the mirror 124 deflects the light beam 123 out of the space between the retroreflectors 120, 122, stopping the cycling of the beam 123 between the retroreflectors 120, 122. For example, if beam 123 makes three passes through retroreflectors 120, as shown in the exemplary illustration of FIG. 6, the transverse displacement of beam 123 exiting at mirror 124 will be 6Δx when the mechanical displacement between the retroreflectors 120 and 122 is Δx. It should be understood that the displacement 6Δx is small compared to the distance between beam paths in the retroreflectors 120, 122, so that on the final pass the whole beam 123 is deflected by mirror 124. The number of passes, and hence the amplification that can be achieved, depends on the size of the retroreflectors 120 and 122, and the diameter of the beam 123. For larger retroreflectors 120, 122 and a smaller diameter beam 123 more passes through the retroreflectors 120, 122 may be possible.

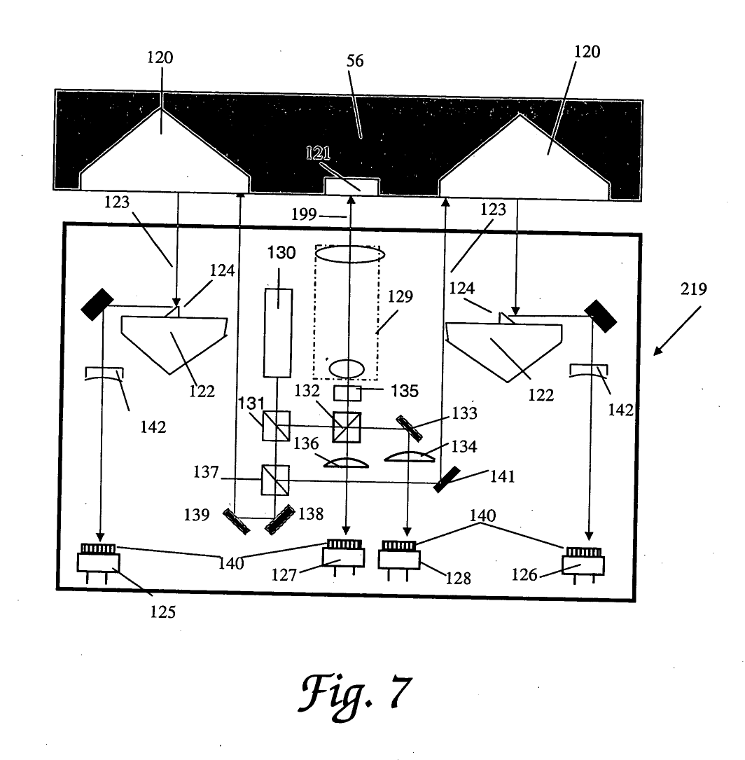

Referring to FIG. 7, a PSD device 219 according to the present teachings incorporates two pairs of first and second retroreflectors 120 and 122 to increase sensitivity to transverse displacements. The PSD device 219 also includes a beam expander 129 to increase sensitivity to pitch and yaw of the beam 199 directed at the plane mirror 121. The volume occupied by the retroreflectors 120, 122 can be reduced by cutting the retroreflectors 120, 122 to remove material from regions where the laser beam 123 does not propagate for this application. The PSD device 219 includes detectors 125 and 126 for monitoring transverse displacements, a detector 127 for monitoring pitch and yaw, and a detector 128 for monitoring laser drift. Each of the detectors 125, 126, 127, 128 for the PSD 219 can be a two-axis position sensitive detector, such as those commercially available from UDT, Hawthorne, Calif. The detector output signal indicates the location of the spot of light on the corresponding detector. An isolator 140 located in front of each of the detectors 125, 126, 127, 128 of PSD device 219 filters out light that is not of the desired wavelength or polarization. Isolators 140 may also prevent light reflected from a detector surface from passing back through isolator 140. Small digital cameras can also be used in place of two-axis position sensitive detectors together with image analysis software to analyze their signals for determining the location of corresponding beam centers. Digital cameras can distinguish between multiple spots due to parasitically reflected laser beams, background light, and the signal the laser is intended to measure.

With continued reference to FIG. 7, a laser 130 of the PSD device 219 produces a beam that is split into two beams by beam splitter 131. The beam reflected by beam splitter 131 is directed to polarizing beam splitter (PBS) 132 where it is again split into two beams. The beam transmitted by the polarizing beam splitter 132 is reflected by the mirror 133 and focused by lens 134 onto detector 128 which monitors drift of the laser beam. The beam 199 reflected by PBS 132 passes through a quarter wave plate (QWP) 135, then through beam expander 129, and then reflected back into the PSD device 219 by mirror 121. On the second pass through the QWP 135 the plane of polarization of the laser beam is rotated by 90° so that it is transmitted through the PBS 132 and focused by lens 136 onto detector 127 which measures the pitch and yaw of carriage 56.

The beam transmitted from beam splitter 131 goes to beam splitter 137 where it is again split into two beams. These beams 123 are directed by mirrors 138, 139 and 141 to retroreflectors 120 on carriage 56. When these beams 123 return to the PSD device 219 they are expanded by concave lenses 142 and detected by detectors 125 and 126. Because the beams 123 are expanded, the detectors 125 and 26 may need larger sensitive areas than detectors 127 and 128, which detect focused laser light. The signals from detectors 125 and 126 can be used to calculate transverse linear displacements and roll of the carriage 56.

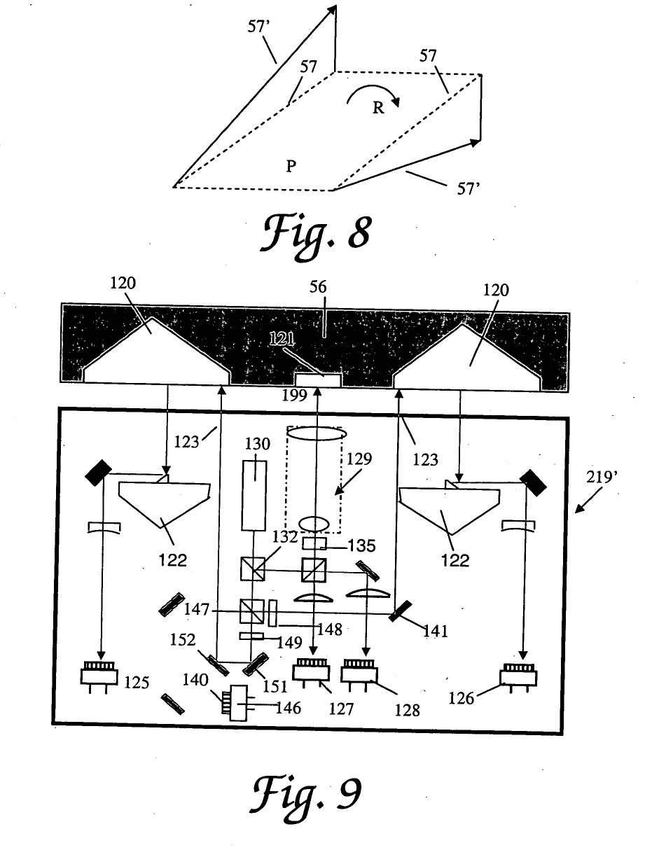

Referring to FIG. 8, another systematic error may be caused by lack of parallelism of the rails 57 on which the carriage 56 moves. In FIG. 8, if the rails 57 are parallel, the rails 57 define a plane “P”. Non-parallel rails, indicated at 57′, however, induce a roll in carriage 56 indicated by curved arrow “R”. The amount of non parallelism shown in FIG. 8 is greatly exaggerated in order to illustrate the effect.

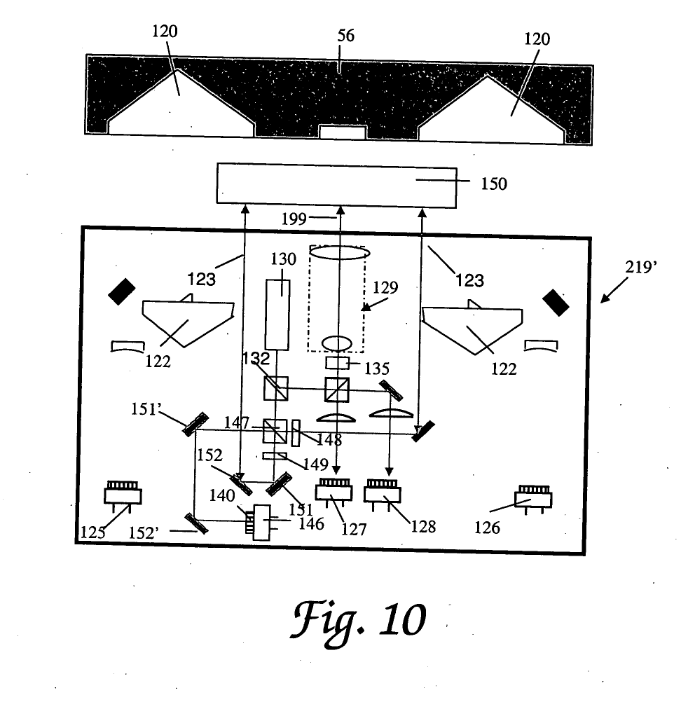

Referring to FIGS. 9 and 10, a PSD device 219′ capable for measuring non-parallelism of the rails 57 is illustrated. In comparison to the PSD device 219 of FIG. 7, the PSD device 219′ of FIG. 9 includes an additional detector 146 having an isolator 140. Furthermore, a polarizing beam splitter 147 and two quarter wave plates 148 and 149 replace the non polarizing beam splitter 137 of FIG. 7. The modified system of FIG. 9 can perform the same measurements as the system of FIG. 7 when the laser beams are directed to retroreflectors 120 and plane mirror 121. A one-time procedure for measuring and correcting non-parallelism of the rails 57 is sufficient and is described in reference to FIG. 10. For this procedure, a removable plane mirror 150 is inserted between the carrier 56 and the PSD device 219′ such that the beams 123 are reflected back on themselves instead of going to the retroreflectors 120. Because the direction of polarization of the return beams is rotated 90° relative to the incident beams by the quarter wave plates 148 and 149, both return beams 123 are directed to mirrors 151′ and 152′, which reflect them onto detector 146. Since each of the return beams 123 has a different direction of polarization, the return beams 123 can be viewed individually by placing a polarizer in front of the detector 146 and rotating it by 90° to first observe one beam 123 and then the other beam 123. The polarizer can improve the resolution of beam location for each of the beams 123. The polarizer can be incorporated into the isolator 140 in front of detector 146, such that rotating the isolator 140 allows the beams to be observed separately.

In practice, the beams 123 that are directed at retroreflectors 120 in FIG. 9 are first approximately aligned using mirrors 141 and 152 so that the spots on detectors 125 and 126 remain in approximately the same location as the carriage 56 moves along the rails 57. After this approximate alignment, the beams 123 are made precisely parallel to each other by inserting the mirror 150 and adjusting mirrors 141 and/or 152 so that both beams are superimposed at the same location on detector 146 as indicated in FIG. 10.

After beams 123 are aligned to be parallel to each other, the mirror 150 is removed. The PSD device 219′ in the configuration shown in FIG. 9, is used to measure motion stage errors. Best fit straight lines are determined through the data of detectors 125 and 126 to obtain transverse displacements from linear motion of retroreflectors 120 as described above. In addition to using transverse displacements to determine transverse straightness errors and roll, the slopes of the linear fits to the data from detectors 125 and 126 can also be used to determine the deviation from parallelism of the rails 57. Any deviation from parallelism of the rails 57 introduces an additional component of roll that can be determined from the difference in slopes of the retroreflector data.

As described above, the PSD device 219 is used to determine five geometric errors, i.e. transverse displacements, pitch, yaw, and roll, of the motion of carriage 56 of an inspection machine 100 inspecting a production part 55 in real time as measurements of production part 55 are being made. This information, together with data on the effect of motion stage errors on detectors 109 measuring mirror 116 also taken in real time, can be used to correct for the effect of motion stage errors on the measurement of production part 55 simultaneously with the measurement of production part 55 by the inspection detectors 51. The effects of both random and repeatable motion stage errors on the measured profile of production part 55 are thus corrected, increasing the resolution of the inspection machine 100.

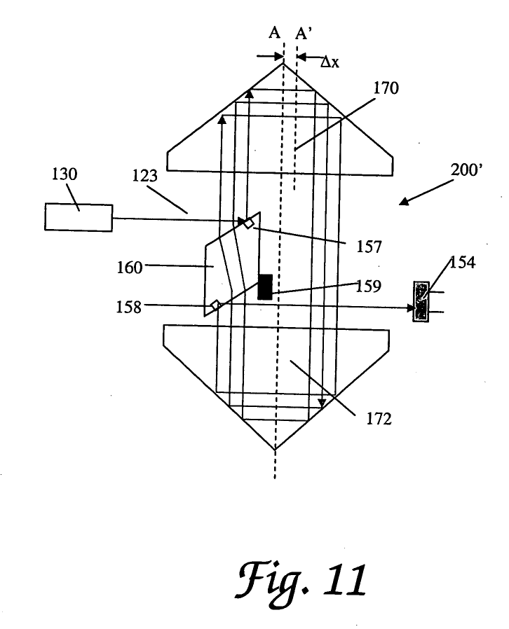

Referring to FIGS. 11-18, other embodiments of the optical amplification system 200 of FIG. 6A are illustrated. In FIG. 11, an optical amplification system 200′ according to the present teachings includes first and second retroreflectors 170, 172, a laser 130 producing a laser beam 123, a transparent plate 160 with mirrors 157 and 158 deposited on opposite faces of plate 160 directing the laser beam 123 into the first and second retroreflectors 170, 172, and a detector 154 detecting the laser beam 123 exiting from the first and second retroreflectors 170, 172. The transparent material of the plate 160 can be glass or other material with high refractive index, such that beams refracted through the plate 160 are displaced relative to each other. The first and second retroreflectors 170, 172 are identical retroreflectors. If the first retroreflector 170 is displaced transversely by a small distance Δx relative to retroreflector 172, such that a central axis A′ of the first retroreflector 172 is displaced by Δx relative to a central axis A of the second retroreflector 172, the output beam 123 to the detector 154 will be displaced a distance 2Δx relative to the path without displacement for each round trip through the retroreflectors 170, 172. In the exemplary illustration of FIG. 11, the beam 123 on detector 154 is displaced by a distance 6Δx. The displacement Δx. is small relative to the distance between adjacent beams in the retroreflectors 170, 172. The glass surfaces of the plate 160 transmitting the laser light are antireflection coated. A beam stop 159 can be inserted after the plate 160 to block undesired multiple beams reflected from the plate surface from reaching detector 154. The plate 160 is aligned so that the mirror 157 reflects the beam 123 perpendicular to the face of the first retroreflector 170 or parallel to the axis A. All beam paths will then be perpendicular to the faces of the first and second retroreflectors 170, 172. When the an incident beam 123 is parallel to the face of the first and second retroreflectors 170, 172, the plate 160 is aligned at an angle of 45° relative to the faces of first and second retroreflectors 170 and 172.

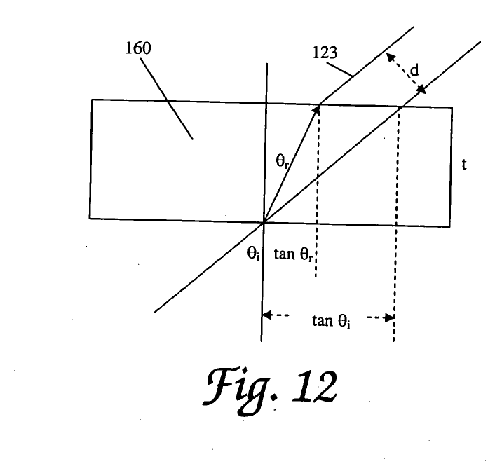

The separation “d” between segments of the beam 123 on sequential passes through plate 160 can be determined from the diagram of FIG. 12. For a sufficient thickness “t” of the plate 160, the segments of the beam 123 on sequential passes will not overlap, and a number of passes can be made through the retroreflectors 170, 172 before the beam 123 is reflected by the mirror 158 onto the detector 154. The distance d between the centers of adjacent beam segments is determined by the following equation:

d=t sin θᵢ(tan θᵢ−tan θᵣ) (1)

where the angle of incidence is θᵢ, the angle of refraction is θᵣ, n is the refraction index and

$$sin {θ}_{r} = \frac{1}{n} sin {θ}_{i}$$

For example, if t=2.0 cm, n=1.5, and θᵢ=45°, then θᵣ=28.1° and d=6.5 mm.

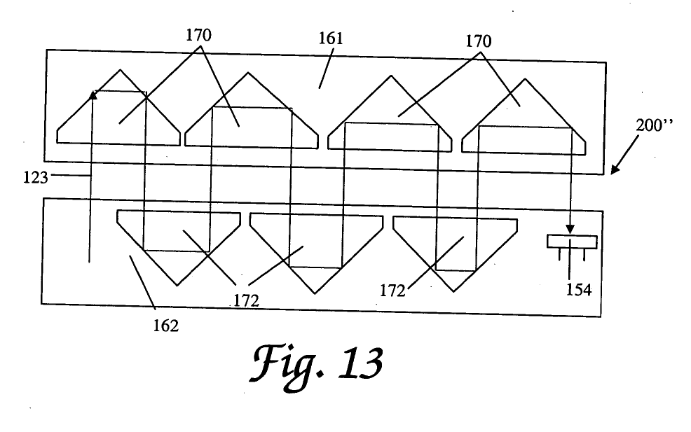

Referring to FIG. 13 an optical amplification system 200″ according to the present teachings includes first and second retroreflector arrays 161 and 162. The first retroreflector array includes a plurality of first retroreflectors 170 fixed relatively to each other in the array 161, and the second retroreflector array 162 includes a plurality of second retroreflectors 172 fixed relatively to each other in the array 162. The first and second retroreflector arrays 161, 162 are placed such that a beam of light 123 can pass through all the retroreflectors 170, 172 and be detected by detector 154. The first array 161 can be shifted transversely by an amount Δx relative to array 162, and each pass through one of the retroreflectors 170 in the first array 161 increases the beam displacement at the detector 154 by an additional 2Δx. The total displacement of the laser beam 123 on detector 154 is 2Δx times the number of retroreflectors 170 in the first array 161. In the illustrative example of FIG. 13, in which there are four retroreflectors 170, beam displacement is amplified by a factor of 8. The displacement Δx. is small relative to the distance between adjacent beams in the retroreflectors 170, 172.

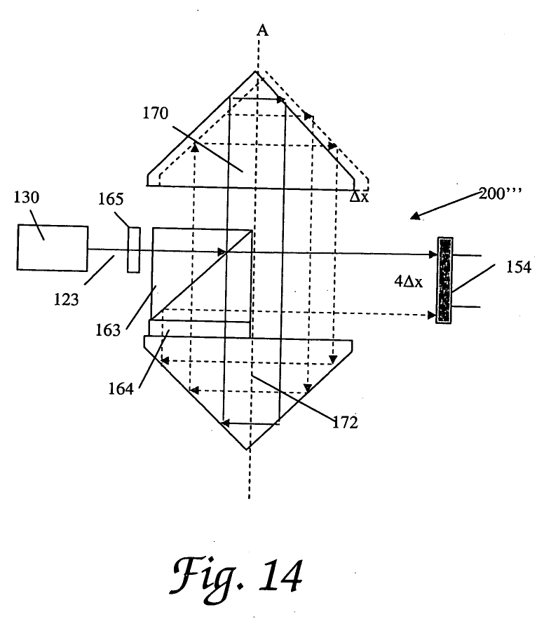

Referring to FIG. 14, an optical amplification system 200′″ according to the present teachings is illustrated. A beam 123 from laser 130 is incident on a linear polarizer 165 that removes any part of the beam 123 that is not reflected by a polarizing beam splitter 163, such that the beam 123 incident on the beam splitter is totally reflected. After passing through first and second retroreflectors 170 and 172, the beam 123 passes through half wave plate 164. The half wave plate 164 is aligned such that the direction of polarization of the light leaving the half wave plate 164 is rotated 90° relative to the incident polarization of the beam 123. The beam 123 is therefore transmitted through the polarizing beam splitter 163 and makes another transit through both retroreflectors 170, 172. On the second pass through half wave plate 164, the plane of polarization of the beam 123 leaving the half wave plate 164 is rotated 90° relative to the polarization of the beam 123 transmitted through the polarizing beam splitter 163, so that the beam 123 is reflected by the beam splitter 163 onto the detector 154. The retroreflectors 170 and 172 are the same size and are aligned with their vertices along the same axis A. Without transverse displacement, the beam paths for multiple round trips through the retroreflectors 170, 172 overlap as shown by solid lines. With the retroreflectors 170, 172 slightly misaligned as the result of a relative displacement Δx in the direction indicated by arrow 156, the spot of light on the detector 154 is displaced by an amount 4Δx relative to the location of the spot on the detector 154 when there is no transverse displacement Δx. The beam path with displacement Δx is indicated by dotted lines. The detector 154 can be a digital camera that can distinguish between weak leakage signals and the main signal onto the detector 154.

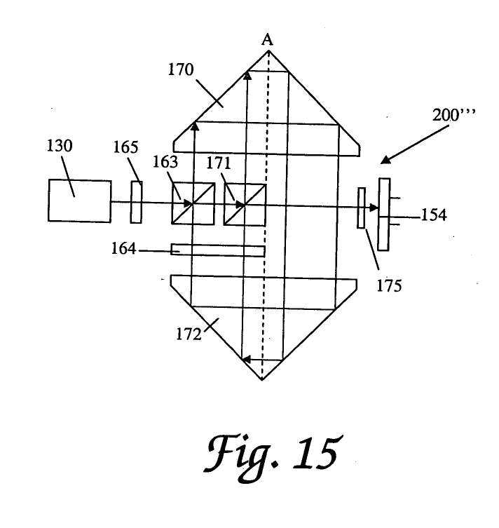

Referring to FIG. 15, the amplification of transverse displacements by the first and second retroreflectors 170 and 172 can be increased to a factor of 8 by using two polarizing beam splitters 163 and 171 on one side of the axis A of retroreflectors 170 and 172. For retroreflectors 170 and 172 that are sufficiently large, more than two beam splitters can be used to obtain even greater amplification. Each additional beam splitter increases the amplification of transverse displacement by 4Δx. The polarizer 165, the beam splitters 163 and 171, and the half wave plate 164 can be attached to each other and to the retroreflector 172 with epoxy. Using an index matching epoxy eliminates reflections between the faces of these components. A polarizer 175 can be used to provide extinction of signals from some beam components with undesirable polarization. The beam splitters 163 and 171 are centered along a diameter of the face of the second retroreflector 172.

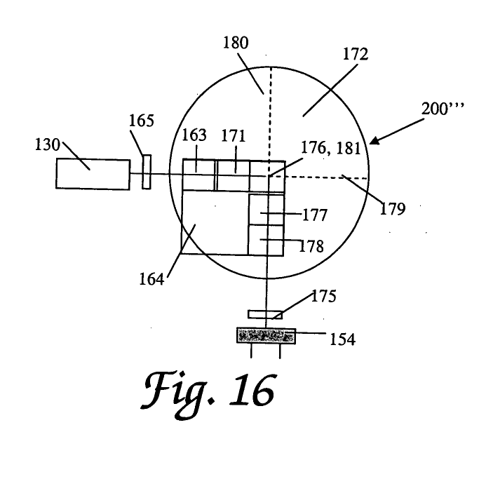

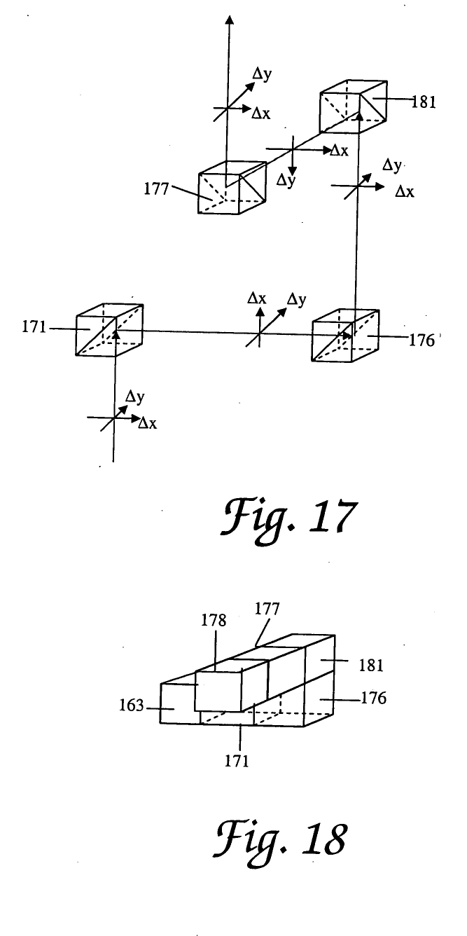

Referring to FIGS. 16-18, the amplification of transverse displacements by the first and second retroreflectors 170 and 172 of FIG. 15 can be doubled again to an amplification factor of 16 by adding two beam splitters 177 and 178 and directing the beam leaving the beams splitter 171 into the beam splitters 177 and 178. The beam splitters 163 and 171 are centered along a diameter 179 of the retroreflector 172. The beam splitters 177 and 178 are centered along a diameter 180 of the beam splitter 172, where diameters 179 and 180 are perpendicular to each other. We define Δx and Δy as the displacements along the direction of diameters 179 and 180 respectively. To ensure that the directions of displacements Δx and Δy in beam splitters 163 and 171 are preserved in the beam splitters 177 and 178, the beam leaving beam splitter 171 is reflected twice before entering the beam splitter 177. These reflections are performed by additional mirrors 176 and 181 which can be stacked on top of each other, as shown in FIG. 17, which illustrates the orientations of the beam displacements leaving each beam splitter. Mirrors 176 and 181 can be either reflective surfaces on the hypotenuse of right angle prisms or reflective surfaces of right angle prisms which are part of glass cubes that provide additional rigidity, as shown in FIGS. 17 and 18. The desired direction of polarization of the beam in each beam splitter can be set using a half wave plate to rotate the plane of polarization.

Combining an amplification of transverse displacements by a factor of 16 together with additional amplification of the transverse displacements by expansion of the laser beam diameter by a factor of 5 increases the total optical amplification for transverse displacements by a factor of 80. Therefore, by using a combination of the methods and systems described herein a very significant amplifications of transverse displacements can be achieved and used to distinguish between transverse straightness errors and roll in a position sensing detector array.

The beam splitters 163, 171, 177, 178, and mirrors 176, 181 can be stacked as shown in FIG. 18, and combined with the half wave plate 164, the polarizer 165 and the retroreflector 172 to form a single unit, eliminating the need for separate mounting hardware for each component and reducing parasitic reflections at glass-air interfaces. A glass spacer can also be inserted between the beam splitters 177 and 178 and the half wave plate 164 to increase rigidity and reduce the number of glass air interfaces. Instead of a large half wave plate 164 a number of smaller half wave plates can also be used. Losses can be reduced further by coating surfaces at glass-air interfaces with antireflection coatings.

Linear polarizers can be inserted anywhere in the system where only a single direction of polarization is to be transmitted, and to help reduce undesirable signals that result from incomplete extinction of these signals.

When two beam splitters are joined together with epoxy, an error in the angle of reflection can be produced if the epoxy layer is not uniform. Therefore, joining the components with epoxy is preferably done in an alignment fixture in which a laser beam passes through the components during the joining procedure to ensure that the components are correctly aligned relative to each other.

While particular embodiments have been described in the specification and illustrated in the drawings, it will be understood by those skilled in the art that various changes may be made and equivalents may be substituted for elements thereof without departing from the scope of the invention as defined in the claims. In addition, many modifications may be made to adapt a particular situation or material to the present teachings without departing from the essential scope thereof. Therefore, it is intended that the present teachings are not be limited to the particular embodiments illustrated by the drawings and described in the specification, but that the present teachings will include any embodiments falling within the foregoing description and the appended claims.

What is claimed is:

1. A method for calibrating an inspection machine including a plurality of displacement detectors for inspecting a production part and a linear motion stage for relative motion between the displacement detectors and the production part, the method comprising:
determining relative positional errors of the displacement detectors relative to each other;
determining the effect of motion stage errors on a first detector from the plurality of displacement detectors as a function of position of the motion stage; and
determining the effect of motion stage errors on the remaining displacement detectors as a function of position of the motion stage.

2. The method of claim 1, wherein determining the relative positional errors of the displacement detectors comprises:
positioning a reference part of known profile on the linear motion stage;
obtaining a detected profile of the reference part from the displacement detectors;
comparing the detected profile to the known profile of the reference part; and
determining correction factors for the relative positional errors.

3. The method of claim 2, further comprising removing the reference part.

4. The method of claim 1, wherein determining the effect of motion stage errors on the first displacement detectors comprises:
positioning a mirror on the motion stage;
sending a signal to the mirror from the first detector;
detecting deviation from linearity of the signal during motion; and
determining the effect of motion stage error on the first detector.

5. The method of claim 4, further comprising removing the mirror.

6. The method of claim 4, wherein determining the effect of motion stage errors on the remaining displacement detectors comprises:
sending a signal to the mirror from each remaining detector;
detecting deviation from linearity of the signal during motion; and
determining the effect of motion stage error on each remaining detector.

7. The method of claim 4, wherein determining the effect of motion stage errors of the remaining displacement detectors comprises:
providing instrumentation for direct motion stage error measurement;
measuring directly motion stage errors; and
determining the effect of motion stage errors on the remaining detectors as a function of position of the motion stage.

8. The method of claim 7, wherein providing instrumentation includes providing instrumentation for measuring yaw, pitch and roll of the motion stage.

9. The method of claim 1, wherein determining the effect of motion stage error on the first displacement detector comprises:
replacing the first detector with a mirror measurement detector when the first displacement detector is not a mirror measurement detector.

10. An inspection machine for a production part comprising:
a plurality of first detectors for measuring a surface profile of the production part;
a linear motion stage for relative motion between the first detectors and the production part;
a strip mirror stationary relative to the production part;
a second detector for measuring displacement between the strip mirror and the second detector; and
a third detector device for simultaneous and continuous measurement of geometric errors of the linear motion stage, wherein the strip mirror, the second detector and the third detector device are configured for determining the effects of motion stage errors on the first detectors such that the motion stage errors can be removed from the surface profile measurement of the production part.

11. The inspection machine of claim 10, wherein the strip mirror has a known surface profile.

12. The inspection machine of claim 10, wherein the strip mirror is formed along an edge of a glass slab mounted on the inspection machine.

13. The inspection machine of claim 10, wherein the second detector obtains displacement measurements for correcting the effects of motion stage errors on displacement at locations occupied by the first detectors.

14. The inspection machine of claim 10, wherein the third detector device comprises a laser beam splitter for splitting a laser beam into first, second and third laser beams for monitoring the motion stage errors.

15. The inspection machine of claim 14, further comprising first and second retroreflectors on the motion stage for reflecting the first and second laser beams, and a plane mirror for reflecting the third laser beam.

16. The inspection machine of claim 15, wherein a displacement of the first and second beams returning from the retroreflectors determines transverse straightness errors and roll of the motion stage.

17. The inspection machine of claim 15, wherein angular displacement of the third laser beam reflected from the plane mirror determines pitch and yaw of the motion stage.

18. The inspection machine of claim 10, wherein the third detector device comprises a first retroreflector facing a second retroreflector mounted on the motion stage, the first and second retroreflectors being configured to optically amplify transverse mechanical displacement by an amplification factor of two for each successive passing of a laser beam through the first and second retroreflectors before re-entering the first and second of retroreflectors.

19. The inspection machine of claim 18, wherein the first and second retroreflectors have different diameters and centers shifted relative to each other.

20. The inspection machine of claim 19, further comprising a deflecting mirror between the first and second retroreflectors for deflecting the beam to a fourth detector included in the third detector device.

21. The inspection machine of claim 19, wherein the third detector device further comprises a plurality of polarizing beam splitters and at least one half wave plate for measuring non parallelism between two rails of the motion stage.

22. The inspection machine of claim 10, wherein plurality of first detectors have reconfigurable positions and orientations.

23. The inspection machine of claim 10, wherein the strip mirror and production part are mounted on the linear motion stage, and the first and second detectors are stationary.

24. The inspection machine of claim 10, wherein the first and second detectors are mounted on the linear motion stage, and the strip mirror and the production part are stationary.

25. The inspection machine of claim 10, wherein the third detector device includes a position sensing detector.

26. The inspection machine of claim 25, wherein the position sensing detector is a position sensitive detector.

27. The inspection machine of claim 25, wherein the position sensing detector is a digital camera.

28. A method for continuously determining the effects of motion stage errors on a plurality of first detectors of an inspection machine having a linear motion stage, wherein the first detectors measure a production part profile, the method comprising:
attaching a strip mirror on the inspection machine;
providing a second detector for measuring displacements from the strip mirror;
providing a third detector device for directly measuring geometric motion stage errors;
measuring continuously and simultaneously geometric errors of the linear motion stage;
measuring displacements between the strip mirror and the second detector;
determining effects of motion stage errors on the second detector; and
removing the effects motion stage errors from the first detectors.

29. The method of claim 28, further comprising optically amplifying transverse mechanical displacements of the motion stage by more than a factor of two.

30. The method of claim 29, wherein optically amplifying transverse displacements comprises:
providing a first retroreflector in the third detector device and a second retroreflector on the motion stage;
splitting a laser beam from the third detector device into first, second and third laser beams;
reflecting the first and second laser beams from the first and second retroreflectors;
detecting the reflected first and second laser beams; and
determining transverse straightness errors and roll of the motion stage.

31. The method of claim 30, further comprising:
reflecting the third beam from a plane mirror of the third detector device; and
determining pitch and yaw of the motion stage.

32. The method of claim 30, wherein reflecting the first and second laser beams from the first and second retroreflectors comprises multiple times reflecting between the first and second retroreflectors.
